(19) United States
(12) Patent Application Publication
(10) Pub. No.: US 2013/0337334 A1
(43) Pub. Date: Dec. 19, 2013

(54) ELECTRODE MATERIAL HAVING A HIGH CAPACITY

(71) Applicants: Chuanqi Tao, Shanghai (CN); Martin Miessen, Marl (DE); Peter Pilgram, Ingolstadt (DE); Stefano Passerini, Muenster (DE); Martin Winter, Muenster (DE)

(72) Inventors: Chuanqi Tao, Shanghai (CN); Martin Miessen, Marl (DE); Peter Pilgram, Ingolstadt (DE); Stefano Passerini, Muenster (DE); Martin Winter, Muenster (DE)

(73) Assignee: Evonik Litarion GmbH, Kamenz (DE)

(21) Appl. No.: 14/000,877

(22) PCT Filed: Jan. 27, 2012
(86) PCT No.: PCT/EP2012/051300

§ 371 Date: Aug. 22, 2013

(30) Foreign Application Priority Data
Feb. 23, 2011 (DE) 10 2011 004 564.3

(51) Int. Cl. H01M 4/133; H01M 4/04

(52) U.S. Cl. CPC H01M 4/133; H01M 4/04
USPC 429/231.8; 29/623.5; 252/502

(57) ABSTRACT

The invention accordingly provides a silicon-carbon composite which has at least a proportion of hard carbon and a proportion of silicon powder and is obtained by, under a noble gas atmosphere, a) treating the hard carbon component at least once with high energy in a mechanofusion mixer and b) subsequently adding the silicon powder component thereto and mixing the components, or adding the silicon powder component during step a) and continuing the mechanofusion treatment, and is characterized in that the composite has an average particle size of less than or equal to 12 μm, a proportion of hard carbon of from 5 to 50% by weight and a proportion of silicon powder of from 5 to 50% by weight.

The invention relates to a microstructured silicon-carbon composite and its use as anode material for lithium ion batteries.

Mobile and portable applications always make relatively challenging demands on storage media for electric energy. Although double-layer capacitors display a large number of charging/discharging cycles, the energy density is significantly lower than in rechargeable battery systems, especially lithium ion batteries. Here, the theoretical capacity of the graphite which is mostly used is 372 mAh/g for a composition of LiC₆. Even higher gravimetric energy densities can be achieved by replacement of the graphite by silicon; here, the capacity for an alloy having the composition Li₂₂Si₅ is 4200 mAh/g. However, an abovementioned complete lithiation of the silicon leads to a volume expansion of more than 300%. The mechanical stress occurring here pulverizes the silicon particles, as a result of which electric contact between silicon and the current-conducting components of a cell decreases greatly within a few charging/discharging cycles and the silicon-based anode quickly loses its capacity.

A very comprehensive overview of the causes and various approaches for overcoming the difficulties in the use of silicon as active component in lithium ion batteries has been given by Kasavajjula, Wang and Appleby (Journal of Power Sources 163 (2007) 1003-1039).

The following approaches for overcoming the problems resulting from the volume expansion are mentioned:
pure Si micro- and nano-scale powder anodes
Si dispersed in an inactive matrix
Si dispersed in an active matrix
Si anodes with different binders
Si thin films

Neither the use of very small crystalline or amorphous Si particles, conventionally applied as slurry or via polyvinylidene fluoride to the current collector, nor the use in intercalatable or else nonintercalatable matrices which have been produced chemically, physically or else mechanically and have been processed using a variety of binder systems have led to silicon-based electrodes having a satisfactory cycling stability.

All these technical teachings have the disadvantage of a high irreversible capacity and numbers of charging and discharging cycles which are too low for practical applications.

The articles by C. S. Wang, Wu, Thang, Qi, Li, Electrochem. Soc 145 (1998) 2751, and G. X. Wang, Yao, Liu, Electrochem. Solid-State Lett. 7 (2004) A250, have discussed the fact that mixing and milling of finely divided silicon powder with carbon in a ball mill leads, as a result of destruction of graphite and MCMB structures, to an electrode material which displays very high irreversible capacities.

It was therefore an object of the present invention to provide a process for producing silicon-carbon composites and the silicon-carbon composite itself which is suitable for use as anode material having a satisfactory capacity and cycling stability in a lithium ion battery.

It has surprisingly been found that when hard carbon is used as carbon source for a silicon-carbon composite, pretreatment of the hard carbon component in the composite under argon in a high-energy mixer improves the subsequent composite formation using silicon powder. If the silicon powder component is added to the mixer after this separate pretreatment of the hard carbon, the resulting mixture is once more treated with high energy and processed further under protective gas, a silicon-hard carbon composite having significantly improved cycling behaviour results.

High-energy mixing, for the purposes of the present invention also referred to as mechanofusion, is a process of treating powder or powder mixtures with high mechanical energy. This is indicated, for example, in the article “Mechanofusion for High Performance Particles”, in Process Engineering, cfi/Ber. DKG 79 (2002), No. 4. Mechanofusion brings about intensive breaking up of the particles of the powder or powder mixture as a result of beating, bouncing, shearing and crushing of the particles. The particles obtained in this way are intensively mixed in mechanofusion. After mechanofusion, large submicron particles which are known to those skilled in the art as “guest particles” and form a coating on the other, larger particles, also referred to as “host particles” are found among the particles. Such an effect has been described as early as 1989 in a study by Yokoyama in “Mechanofusion” from the Micromeritics Laboratory, Hosokawa Micron Corp. Osaka, Japan, 1989. In the coating, the guest particles can be bound to one another and to the surface of the host particles by adhesion forces. Depending on the magnitude of the energy input by means of mechanofusion and the type and size of the host and guest particles, the bonds between the guest particles or the guest and host particles can also be chemical in nature or formed by sintering.

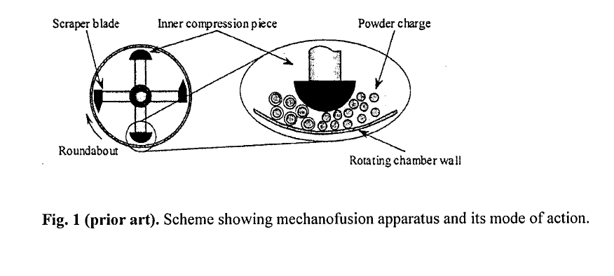

The apparatus for mechanofusion is shown schematically in FIG. 1. The “roundabout” is set into rotation at rotation speeds of from 200 to 3100 rpm so that the particles are pressed against the interior wall of the roundabout by centrifugal forces and are pushed through the gap between “scraper blade” or “inner compression piece” and the interior wall. Not shown in the figure are water cooling and protective gas connection.

The introduction of mechanical energy by means of scraper blades and inner compression pieces applies a beating, bouncing, shearing and crushing action on the particles. The totality of these effects is so intensive that heat energy is also evolved. Depending on the magnitude of the energy input and the type and size of the host and guest particles, the bonds between the guest particles or the guest and host particles can also be chemical in nature or have been formed by sintering.

In the present invention, a complex combination of macroscopic and microscopic processes, whose effect depends greatly on the energy input, occurs. In mechanofusion, particles can be mixed, their morphology can be modified or they can be joined or fused to one another.

The invention accordingly provides a silicon-carbon composite which has at least a proportion of hard carbon and a proportion of silicon powder and is obtained by, under a noble gas atmosphere,
a) treating the hard carbon component at least once with high energy in a mechanofusion mixer and
b) subsequently adding the silicon powder component thereto and mixing the components, or adding the silicon powder component during step a) and continuing the mechanofusion treatment,
   and is characterized in that the composite has an average particle size of less than or equal to 12 μm, a proportion of hard carbon of from 5 to 50% by weight and a proportion of silicon powder of from 5 to 50% by weight.

The term “mixing” refers to any process known to those skilled in the art in which powder or powder mixtures are mixed.

The two-stage processing has the advantage that the silicon particles are very uniformly distributed on the hard carbon particles and adhere to these better than in methods according to the prior art. There is very good electrical contact between the silicon particles and the irregularly arranged stacks of graphene which are typical of hard carbon and will for the purposes of the invention also be referred to as “carbon matrix”. Without being tied to a theory, the inventors believe that the high cycling stability during use as anode material is achieved as a result of the stable electrical contact with the carbon matrix. This ensures a high reversible capacity and the battery produced from this electrode material displays better cycling behaviour.

The carbon matrix of the composite of the invention has a pore structure which is optimally matched to the morphology of the silicon particles. The matched pore structure makes it possible to compensate volume changes during the charging/discharging process, which is the same thing as lithiation/delithiation, ideally without mechanical stressing of the carbon matrix. The mechanical stresses occurring as a result of the volume expansion or contraction during lithiation or delithiation are dissipated in the pores of the carbon matrix.

Although sometimes large volume changes occur in the crystalline and/or amorphous phases of the ion-intercalating particles during cycling or the charging/discharging process, the bonding of these particles to one another is maintained in the composite of the invention. Electronic contact is therefore ensured in the composite of the invention.

A further advantage of the silicon-carbon composite of the invention is that it can be used for producing anode slurries both with and without further treatment steps. Such anode slurries can be solvent-based or water-based and can be produced by methods known to those skilled in the art.

The invention therefore likewise provides for the use of the microstructured silicon-carbon composite of the invention as anode material in energy storage systems and also the use of the silicon-carbon composite obtained by the process claimed in energy storage systems.

The invention further provides a lithium ion cell which comprises the silicon-carbon composite produced by the process of the invention.

The present invention further provides a lithium ion battery which comprises the silicon-carbon composite produced by the process of the invention.

The invention will be explained in more detail below.

The silicon-carbon composite of the invention is obtained under a noble gas atmosphere. The continued exclusion of oxygen in all steps is necessary because undesirable oxidation is avoided in this way. However, molecular nitrogen is unsuitable as inert gas because it reacts with silicon under the action of the energy introduced in the mechanofusion process of hard carbon to form undesirable silicon nitride.

Preferred noble gases under which the silicon-carbon composite of the invention is obtained are helium, neon, argon, krypton, xenon, of which argon is particularly preferred.

Preference is given to using silicon powder, obtainable from Evonik Degussa GmbH, which has been produced by thermolysis of silane and has agglomerates which have sizes of less than or equal to 1 μm and are composed of rounded primary particles having diameters of from 20 to 60 nm.

The mechanofusion in step a) is preferably carried out at from 2500 to 3100 rpm, particularly preferably at 3100 rpm, for a period of from 60 to 360 minutes, particularly preferably 60 minutes.

The silicon powder component of the silicon-carbon composite of the invention can preferably be added after step a) and the components can be mixed by continuing the mechanofusion treatment. This has the advantage of a dramatically further increased cycling stability of the resulting composite in a lithium ion battery. The silicon particles adhere better to the hard carbon particles than when the components are mixed by processes other than mechanofusion. The mechanofusion treatment in step b) is preferably carried out at from 2500 to 3100 rpm, particularly preferably at 3100 rpm, and for a time of from 60 to 360 minutes, particularly preferably 60 minutes. The further advantage of this procedure is that the Si agglomerates are partly broken up and the individual Si particles are incorporated into the surfaces of the hard carbon particles.

Hard carbon is a very hard but brittle substance which can be produced from quite different organic precursor materials such as petroleum pitch, sugar, cellulose, phenolic resins and more by pyrolysis in the absence of oxygen. Hard carbon has good electrical conductivity but also a high microporosity and mesoporosity and also low long-range order of the graphene layers.

The irregularly arranged graphene layers cannot be ordered even by application of very high temperatures and hard carbon therefore does not graphitize. The closed microporosity, which is not directly joined to the exterior surface of hard carbon, produces a density of about 1.5 g/cm³ which is significantly lower than that of graphite having a density of 2.26 g/cm³ but also brings about a very high irreversible capacity of the composite of the invention in the first cycles and also a specific capacity which is lower than that of graphite.

Hard carbon usually has water in the pores, which has to be driven off by drying under reduced pressure at elevated temperature, preferably at 150° C. and an ambient pressure reduced to 1 mbar, before use of the hard carbon.

Particular preference is given to a weight ratio of hard carbon to silicon powder of 8:2.

Possible after-treatment steps include further stabilization of the composite of the invention by application of carbon and/or binder layers which can also be metallic in a manner known to those skilled in the art.

The silicon-carbon composite of the invention is particularly suitable for use in rechargeable lithium-ion batteries in which one electrode comprises a lithium-transition metal mixed oxide of the general formula LiMO₂, where M=at least one metal selected from the group consisting of Co, Ni, Mn, V and/or a lithium-transition metal phosphate of the general formula LiMPO₄, where M=at least one metal selected from the group consisting of Fe, Mn, Co. This electrode is the positive electrode.

### COMPARATIVE EXAMPLE

Hard carbon and silicon powder were intensively mixed in a weight ratio of 8:2 under argon in a planetary ball mill (Fritsch Pulverisette 6) using Sialon milling media in a Sialon milling container with gas introduction lid (16 hours, 500 rpm). The material obtained was processed to give anode material and electrochemically characterized as described below.

15% by weight of “Super P Leitfähigkeitserhöher”, obtainable from Timcal, Switzerland, and 8% by weight of sodium carboxymethylcellulose, obtainable as a commercial chemical, for example from Fluka, Buchs, Switzerland, as an aqueous, nitrogen-deaerated solution were added to 77% by weight of the material obtained above, homogenized, degassed and applied by means of a doctor blade having a gap of 100 μm to a 14 μm thick copper foil. Drying was carried out under nitrogen for 30 minutes at 80° C. and 120 minutes at 110° C. The stamped-out 12 mm thick electrodes were dried further overnight at 130° C. under reduced pressure before assembly of the half cells and combined with lithium as counterelectrode and reference electrode at a pressing pressure of 6.6 bar in a glove box to give half cells (known as T cells, Swagelok, USA). Celgard 2320 (Celgard, USA) was used as separator and a mixture of EC:EMC:DEC:VC=29:49:20:2 (Ferro Corp., USA) was used as electrolyte.

Electrochemical characterization was carried out using a Maccor S4000 battery tester (Maccor, USA). The cells were cycled in the CCCV mode from 0.02 to 1.5 V, in each case the shutdown points. In the first charging step (lithiation), charging was carried out at 0.1 C and discharging carried out at 0.3 C (delithiation). The further charging and discharging steps were carried out at 0.5 C.

### EXAMPLE 1

Hard carbon produced from petroleum pitch and procured from Kureha Corp., Japan under the trade name Carbotron P was used. It had an average particle diameter of 10 μm.

8 parts of hard carbon were treated separately with a high energy input at 3100 rpm for 60 minutes under argon in a AMS-Lab mechanofusion mixer before addition of two parts of silicon powder. After this first treatment stage, the silicon powder was added under argon. Hard carbon and silicon powder were treated together with a high energy input for a further 60 minutes at 3100 rpm in the mechanofusion mixer, then discharged under argon.

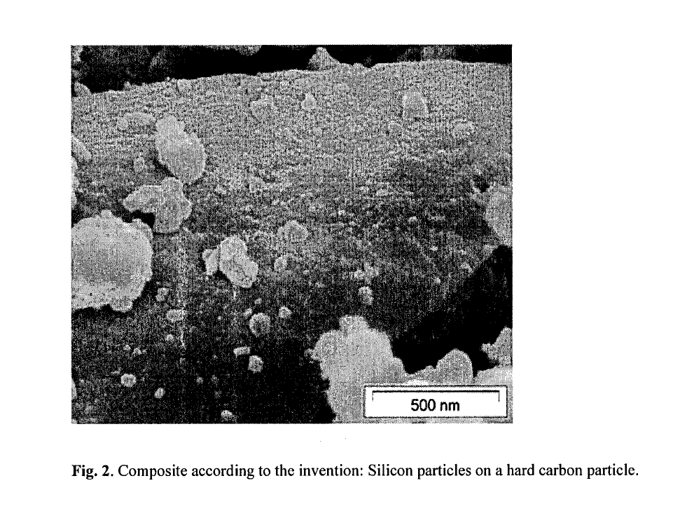

A scanning electron micrograph of silicon particles on a hard carbon particle of the composite according to the invention is shown in FIG. 2.

The composite according to the invention was subsequently processed as in the comparative example to give anode material and electrochemically characterized.

### EXAMPLE 2

8 parts of hard carbon and 2 parts of silicon powder were used as in Example 1, but joint mixing was carried out at 3100 rpm for 60 minutes under argon from the beginning.

The silicon-carbon composite according to the invention was subsequently processed as in the comparative example to give anode material and electrochemically characterized.

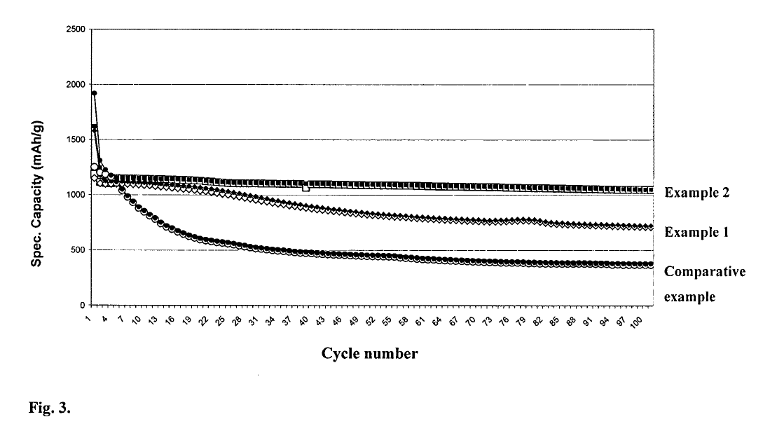

FIG. 3 shows the specific capacity of the half cell as a function of the cycle number, in each case using the electrode material produced in Examples 1, 2 and the Comparative Example. Solid (black) symbols indicate the specific capacity measured during charging, open symbols indicate the specific capacity measured during discharging of the half cell.

1. A silicon-carbon composite, comprising:
from 5 to 50% by weight of hard carbon and
from 5 to 50% by weight of silicon powder,
wherein the silicon-carbon composite is obtained under a noble gas atmosphere by a process comprising:
treating the hard carbon at least once with high energy in a mechanofusion mixer and
subsequently adding the silicon powder thereto and mixing the hard carbon and the silicon powder, or adding the silicon powder during the treating and continuing the treating, and
wherein the silicon-carbon composite has an average particle size of less than or equal to 12 μm.

2. The silicon-carbon composite according to claim 1,
wherein the noble gas atmosphere is argon.

3. The silicon-carbon composite according to claim 1,
wherein the silicon powder is added after the treating and the treating is continued.

4. A method for producing a lithium-ion battery, comprising:
producing the lithium-ion battery with the silicon-carbon composite according to claim 1, as an active component,
wherein the silicon-carbon composite is processed together with a conductivity increaser and a binder to give a paste to be applied to a power outlet lead.

5. A lithium ion battery, comprising
the silicon-carbon composite according to claim 1.

6. The lithium ion battery according to claim 5,
wherein the silicon-carbon composite is processed together with a conductivity increaser and a binder to give a paste to be applied to a power outlet lead.
